(19) United States
(12) Patent Application Publication
(10) Pub. No.: US 2017/0102078 A1
(43) Pub. Date: Apr. 13, 2017

(54) HYDRAULIC AND PROGRAMMABLE HYDRA SEAL GATE VALVE AND REMOTELY OPERATED FRACTURING STACK

(71) Applicant: ZP Interests, LLC, Houston, TX (US)

(72) Inventors: Hernani G. DeOcampo, Spring, TX (US); Balazs Horvath, Spring, TX (US)

(21) Appl. No.: 14/877,213

(22) Filed: Oct. 7, 2015

(51) Int. Cl. F16K 3/02; F16K 37/00

(52) U.S. Cl. CPC F16K 3/0218; F16K 3/0227; F16K 3/0254; F16K 37/0041

(57) ABSTRACT

A gate valve system for controlling fluid flow having a valve body with a bore through which fluid can flow. The system may include a hydra seal assembly for forming a tight seal against the gate of the valve. A programmable logic controller (PLC) may further control the operation of the gate and the hydra seal assembly, and a frac stack may be remotely and automatically controlled for remote operation.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

The following description relates to fluid control valves. For example, a fluid control valve may include hydraulically actuated sealing components for preventing debris, chemicals, and sand from entering the internal body cavity of hydraulic fracturing equipment and valves. The gate and sealing components may be actuated remotely and automatically by a programmable logic controller.

2. Description of Related Art

Industrial piping relies upon many types of valves, but by far the most prevalent are gate valves, which are used in applications where it is desired to prevent or allow flow of fluid through piping with high coefficient of flow (Cᵥ). Gate valves are particularly useful when minimal flow restriction is desired. Gate valves operate by having a planar member, the gate, which moves in a cavity within the valve. The gate can be translated within the gate valve so that an opening in the gate is in alignment with the flow passageway of the gate valve, an open position in which the gate valve allows fluid to flow through it from one side to the other. However, if the gate is translated to a position so that the opening within the gate is sufficiently out of alignment and unregistered with the flow passageway, a closed position, the flow through the gate is blocked such that fluid does not pass from one side of the gate valve to the other.

One common way of translating the gate within the valve is by manually rotating a hand-wheel. The hand-wheel is typically attached to a threaded area within the gate valve system so that when the wheel turns, it moves a stem attached to the gate and causes the gate to translate linearly within the valve body housing. When the gate reaches one end of its region of motion within the gate valve, it is in the open position; when it reaches the other end, it is in the closed position.

Another way of translating the gate within the valve is through the use of a hydraulic actuation device. With a hydraulic actuation device, hydraulic pressure can be utilized to open and close the gate valve. This is particularly useful where a large amount of force would be needed to open or close the valve, for example, when gates are under relatively high pressure differentials between one side of the valve and the other. Hydraulic and motorized or other electrical actuation devices provide a way to operate the valve where the force required to turn a hand-wheel is too large. These types of actuation devices are desirable where automation is required.

Gate valves such as fracturing (or frac) valves used in frac stacks and other associated high-pressure valves must be operated under or with high pressure. Additionally, sometimes frac valves require high torque to force the gate open and closed due to the high pressures that are pressing against the open or closed gate of the frac valve. Frequently, frac stack valves fill with debris during the fracturing process by debris leaking through the connection between the gate and the valve aperture resulting in the valve gate becoming unable to fully open or close, creating a dangerous or unsafe environment.

While frac stack valves and fittings have tightly controlled inside and outside parameters, there must be loose or relaxed tolerances in order for a frac valve gate to travel in and out of the valve body cavity. Accordingly, due to such loose tolerances, a gate cannot properly and adequately seal against or seat on one or both sides while in the open position or the closed position. Conversely, the tolerances and packing or seal may fit loosely against the gate face but may be too loose and thus, susceptible to permitting chemical or debris to enter valve body cavity during the fracturing process. This causes operational problems, which include the inability to fully close the gate, to fully open the gate, or to damage the seal surface of the gate, by corrosion, washed seats or the like.

Further, a frac stack is typically operated under high pressure conditions. An operator typically uses a combination of manual and hydraulic actuation mechanisms to control the opening and closing of the gate. Additionally, an operator may control the actuation of other components within each individual frac valve in a frac stack based on the position of the gate within each valve. For example, an operator may typically need to refer to a position of a gate within a frac valve in order to control the operation of sealing components used in the frac valve.

### SUMMARY OF THE INVENTION

In an aspect, a gate valve system includes a valve body having a bore configured to allow fluid to pass through the valve body, a gate disposed within the cavity and comprising a passage configured to allow fluid to pass, a gate actuation mechanism configured to actuate the gate for substantially permitting or impeding fluid flow, a seal assembly adjacent to the gate configured to be actuated for compressing against the gate, and a programmable controller configured to control the gate actuation mechanism and actuation of the seal assembly.

In another aspect, a gate valve system includes a valve body comprising a bore configured to allow fluid to pass through the valve body, a gate disposed within the cavity and comprising a passage configured to allow fluid to pass, a gate actuation mechanism configured to actuate the gate for substantially permitting or impeding fluid flow, a seal assembly adjacent to the gate configured to be actuated for compressing against the gate, and a switch mechanism for detecting a position of the gate actuation mechanism and the gate.

In yet another aspect, a method of using a gate valve system having a gate and a seal assembly includes actuating the gate to a fully open position using a hydraulic actuator, detecting the fully open position of the gate using a first switch, and actuating the seal assembly to a sealing position in response to the detecting of the fully open position.

### BRIEF DESCRIPTION OF THE SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 is a diagram illustrating an example of a gate valve assembly with a hydraulic actuator, a main valve, and mechanical indicator switches.

FIG. 2 is a diagram illustrating a cross-sectional view of an example of a gate valve assembly including a hydra seal, a valve seat, a valve gate, and an indicator stem.

FIG. 3 is a diagram illustrating an example of a valve body area including hydraulic supply ports to hydra seal cavities and independent hydra seal mechanisms.

FIG. 4 is a diagram illustrating a cross-sectional view of an example of a valve body including hydraulic supply ports to hydra seal mechanisms.

FIG. 5 is a diagram illustrating an example of a hydraulic supply and control diagram for the operation of a gate valve including hydra seal mechanisms and a programmable logic controller.

FIG. 6 is a diagram illustrating an example of a prior art frac stack for hydraulic fracturing operation.

FIG. 7 is a diagram illustrating an example of a remotely operated frac stack for hydraulic fracturing operation including hydra seal mechanisms and a programmable logic controller.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The Figures and written description are provided to teach any person skilled in the art to make and use the inventions for which patent protection is sought. The invention is capable of other embodiments and of being practiced and carried out in various ways. Those skilled in the art will appreciate that not all features of a commercial embodiment are shown for the sake of clarity and understanding. Persons of skill in the art will also appreciate that the development of an actual commercial embodiment incorporating aspects of the present inventions will require numerous implementation—specific decisions to achieve the developer's ultimate goal for the commercial embodiment. While these efforts may be complex and time-consuming, these efforts nevertheless would be a routine undertaking for those of skill in the art having the benefit of this disclosure.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity in specific reference to the Figures and are not intended to limit the scope of the invention or the appended claims. Further, it should be understood that any one of the features of the invention may be used separately or in combination with other features. Other systems, methods, features, and advantages of the invention will be or become apparent to one with skill in the art upon examination of the Figures and the detailed description. It is intended that all such additional systems, methods, features, and advantages be included within this description, be within the scope of the present invention, and be protected by the accompanying claims.

Reference will now be made in detail to an implementation consistent with the present invention as illustrated in the accompanying drawings. For the purpose of clarification, embodiments described herein reference the term “fluid,” which refers to a gas, liquid, as well as liquid solution with solid aggregates, as well as any material that can reasonably be expected to flow.

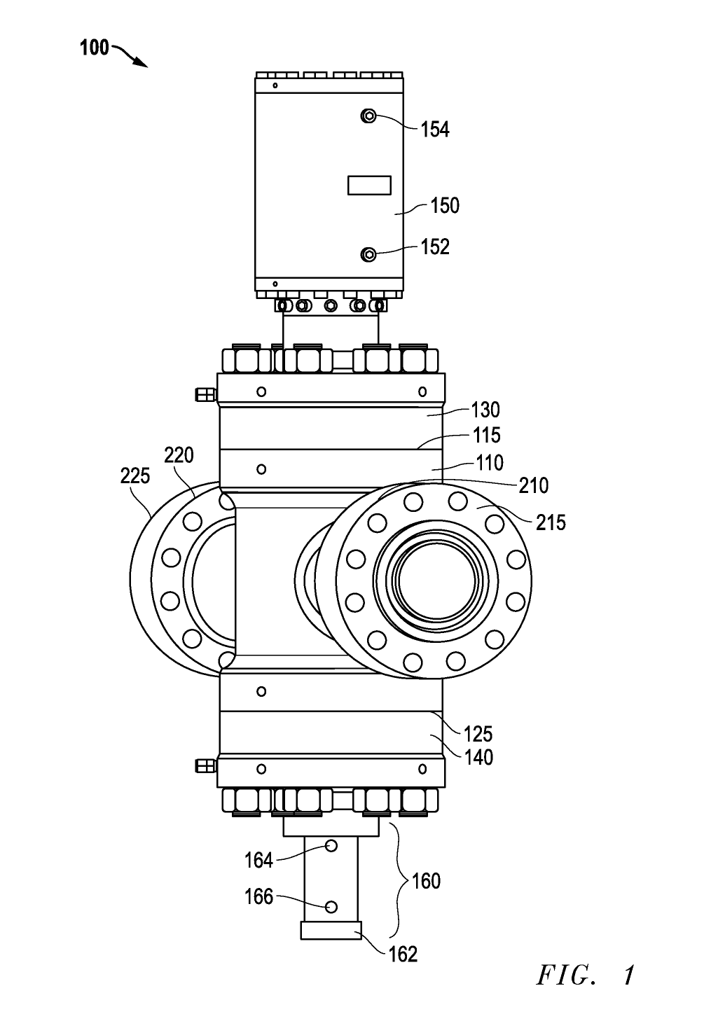

Referring to FIG. 1 by way of non-limiting example, and consistent with embodiments of the invention, a gate valve system 100 is shown. The gate valve system 100 includes a valve body 110 having a pair of flanges 210, 220 at opposing ends of the valve body 110. Flanges 210, 220 are designed to accommodate a flange seal (not shown), such as, but not limited to, a metal gasket, on the flange surfaces 215, 225 to enable the gate valve system 100 to connect to other components with flanges. While this embodiment shows a flange type connection, other ways to provide connections are known within the art and can be designed as appropriate for the valve body 110 and related equipment. The valve body 110 also has a top valve face 115 and a bottom valve face 125 to attach additional components, as desired, to form the gate valve system 100. The gate valve system 100 further includes a first bonnet 130, which is removably attached to the top valve face 115 of the valve body 110. The gate valve system 100 also includes a second bonnet 140, which is attached to the bottom valve face 125 of the valve body 110. The gate valve system 100 further includes a hydraulic actuation mechanism 150 connected to the first bonnet 130 and a detection mechanism 160, connected to the second bonnet 140. The hydraulic actuation mechanism 150 includes an open hydraulic supply port 152 for opening and a close hydraulic supply port 154 for closing the gate valve system 100. One of skill in the art will recognize that various commercially available detection mechanisms can be adapted for use with the gate valve system 100.

The first and second bonnets 130, 140 are removable and interchangeable. Further description is provided with respect to the structure and interchangeability of the bonnets 130, 140 in U.S. patent application Ser. No. 13/762,005, now issued as U.S. Pat. No. 9,091,351, which is hereby incorporated by reference for all purposes.

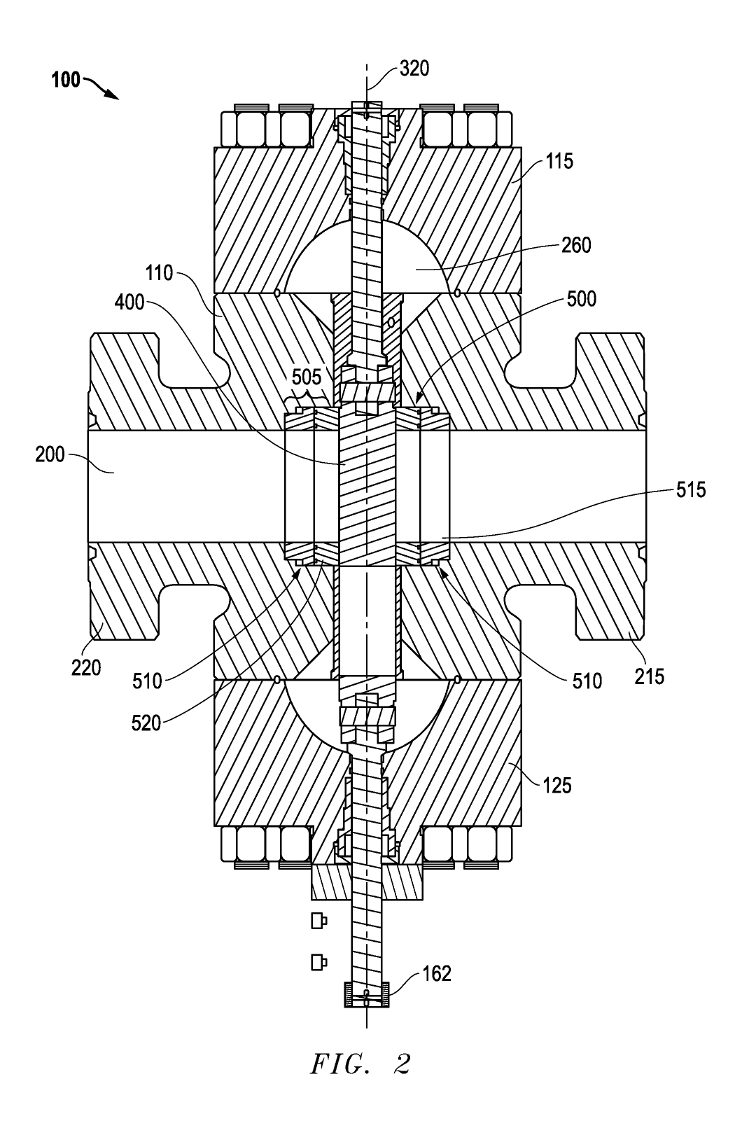

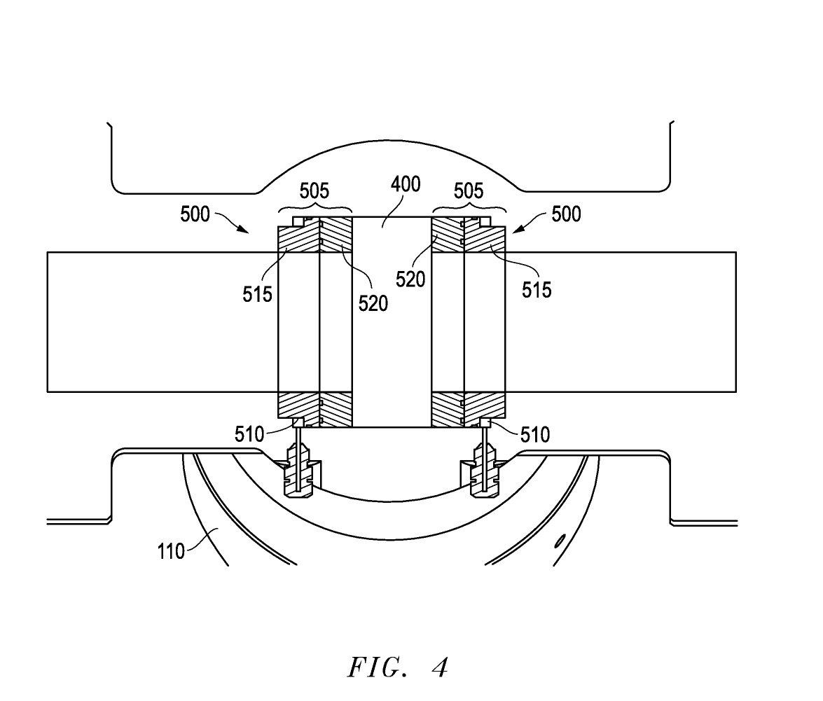

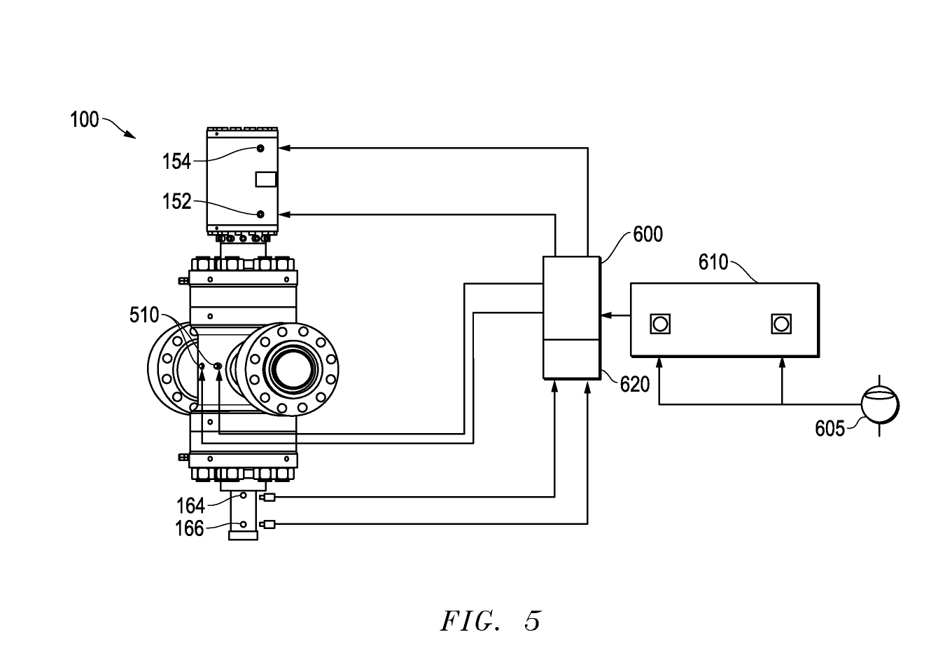

In this example, the detection mechanism 160 includes an indicator stem 162 with an open limit switch 164 and a close limit switch 166. The open limit switch 164 when activated is capable of signaling an operator or a programmable logic controller (PLC) 600 (see FIG. 5) that a gate 400 (see FIGS. 2 and 4) of the gate valve system 100 is in a completely open position that does not block fluid flow. Similarly, the close limit switch 166 when activated is capable of signaling an operator or a PLC that the gate 400 is in a completely closed position that blocks fluid flow. An explanation of the open limit switch 164 and the close limit switch 166, and interactions with the PLC 600 will be explained in greater detail in connection with the PLC 600 and hydra seal operations as provided in FIG. 5.

FIG. 2 is a diagram illustrating a cross-sectional view of an example of a gate valve assembly 100 including hydra seal assemblies 500, hydra seal bores 505, hydra seal injection ports 510, valve seals 515, valve seats 520, the valve gate 400, and the indicator stem 162. The valve seals 515 may also be referred to as energizer rings.

The valve body 110 contains a body bore 200 through which fluid can travel when the gate valve system 100 is in an open configuration such that there is not substantial restriction to the flow of fluid between flange 210 and flange 220. The valve body 110 also contains a main valve cavity 260 about a cavity center-line 320. The cavity center-line 320 passes through the center of the valve body 110 and through the top valve face 115 and bottom valve face 125. The main valve cavity 260 is symmetric about the cavity center-line 320 and is disposed perpendicular to the body bore 200 thereby permitting a gate 400 to travel within the valve body 110.

Referring now to FIG. 2, a sectional view of the valve body 110 is shown wherein the valve body 110 further comprises two substantially identical hydra seal assemblies 500. Each hydra seal assembly 500 is made up of a gate seal 515 for activation by hydraulic pressure and a gate seat 520 for pressing up against the valve gate 400 in response to actuation of the gate seal 515. The valve body 110 includes horizontally machined bores 505, or pockets, for installation of the hydra seal assemblies 500. Injection ports 510 are machined in the valve assembly 100 to inject pressure from an outside source to pass into the hydra seal assembly 500 for activation. Although two injection ports 510 are show for simplicity, any number of injection ports 510 can be used.

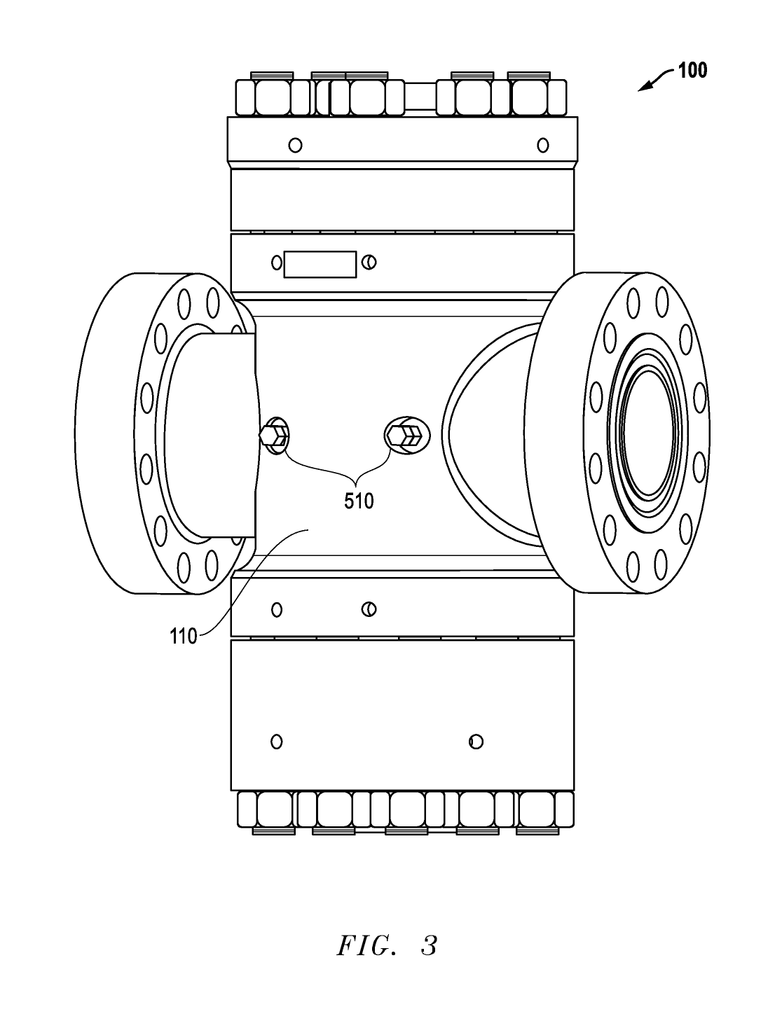

FIG. 3 is a diagram illustrating an outside view of an example of the gate valve assembly 100 including two injection ports 510 on the outer surface thereof. With reference to both FIGS. 2 and 3, the injection ports 510 are configured to be connected to a hydraulic supply that will control the actuation of the hydra seal assemblies 500 for sealing of the valve seats 520 against the valve gate 400 when the valve gate 400 is in a gate closed position. The sealed position may also be referred to as the hydra seal assemblies' 500 closed position. Also, prior to opening of the valve gate 400 into a gate open position, removing pressure in the bores 505 using the injection ports 510 allows the valve seats 520 to return to a non-sealed or hydra seal assemblies' 500 open position that does not interfere with movement of the valve gate 400.

FIG. 4 is a diagram illustrating a cross-sectional view of an example of a valve body 110 including hydraulic injection ports 510 and hydra seal assemblies 500. Valve seat seals 515 are installed onto the back of the valve seat 520. Two valve seats 520 are installed into the two inward pocket bores 505. Two valve seats 520 form a piston effect moving inward towards the center of the valve body 110 and against valve gate 400. For example, when outside pressure is injected through the injection ports 510 located in valve body 110, and into seal assemblies pocket bores 505, the pressure is held by valve seals 515 and is transferred to the back of the valve seats 520. The applied pressure on valve seats 520 forces valve seats 520 against valve gate 400 creating a pressure seal area. While injection pressure is applied through the injection ports 510 on valve body 110, no pressure can enter into the main valve cavity 260, thus preventing the valve gate 400 to operate or move.

FIG. 5 is a diagram illustrating an example of the gate valve assembly 100 including a PLC 600 for controlling the pressure of hydraulic supply 605 to the open and close ports (152 and 154, respectively) of the hydraulic actuation mechanism 150 of the valve gate 400 and to the injection ports 510 of the hydra seal assemblies 500. Additionally, the PLC 600 includes a signal receiving unit 620 for detection of the open limit switch 164 and the close limit switch 166 used for determining the open and closed position of the valve gate 400 as described above. The PLC 600 also includes a panel 610 that allows an operator to monitor the automatic control of the valve gate 400 or hydra seal assembly 500 actuation process, or to manually override the actuation mechanisms of both or either process.

In an example of opening the gate valve 100, before valve gate 400 travels from a closed to an open position, functioning through control of the PLC 600, a delay is set for the hydraulic supply pressure to the hydraulic actuation mechanism 150 thus preventing any premature movement of the valve gate 400 while the hydra seal assemblies 500 are engaged with the valve gate 400. It should be appreciated that the hydra seal assemblies 500 are engaged when the hydra seal bores 505 are pressurized. The hydraulic actuation mechanism 150 is the driving mechanism that moves the valve gate 400 from close to open or vice-versa. The time delay provides operational assurance that the pressure inside the hydra seal assemblies 500 is sufficiently depleted or zeroized. This will be indicated in a pressure gauge (not shown) located on the hydraulic panel 610. After the time delay, the hydraulic supply pressure is routed into the open port of the hydraulic actuation mechanism 150, thus opening the gate valve 100. After the gate valve 100 reaches the fully open position, a signal from a position proximity limit switch in the indicator stem 162 is sent to a solenoid valve to allow hydraulic pressure supply to the hydra seal assemblies 500 to be engaged.

In an example of closing the gate valve 100, before the valve gate 400 commences to travel from open to close, a delay is set for the hydraulic supply pressure to the hydraulic actuation mechanism 150 thus preventing any premature movement of the gate while the hydra seal assemblies 500 are engaged with the valve gate 400. It should be appreciated that the hydra seal assemblies 500 are engaged when the hydra seal bores 505 are pressurized. The time delay provides operational assurance that the pressure inside the hydra seal assemblies 500 is sufficiently depleted or zeroized. This will be indicated in a pressure gauge (not shown) located on the hydraulic panel 610 pressure gage. After the time delay, the hydraulic supply pressure is routed into the close port of the hydraulic actuation mechanism 150 thus closing the gate valve 100. After the gate valve 100 reaches the fully closed position, a signal from the indicator stem 162 position proximity limit switch is send to a solenoid valve to allow hydraulic pressure supply to the hydra seal assemblies 500 to be engaged.

In an aspect, the hydra seal assembly 500 is only engaged when the hydra seal bore 505 is pressurized. The hydra seal assembly 500 is disengaged when the pressure in the hydra seal bore 505 is depleted or zeroed. When both hydra seal assemblies 500 are engaged, it will create an extremely tight seal between the seat 520 and the gate 400 thus preventing any debris, chemicals, or sand from entering the internal body cavity of hydraulic fracturing equipment and valve.

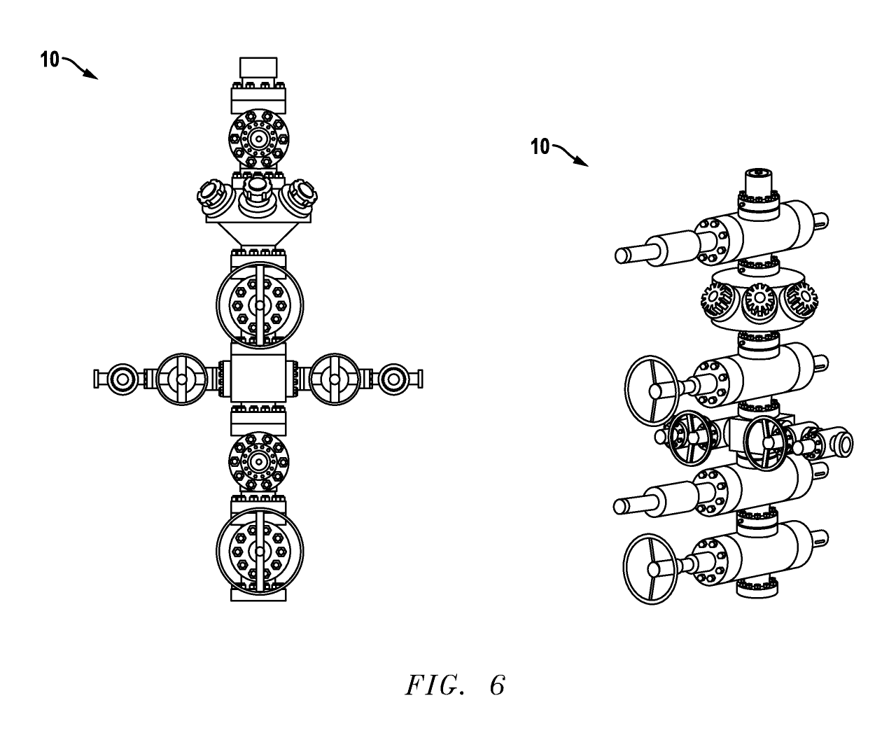

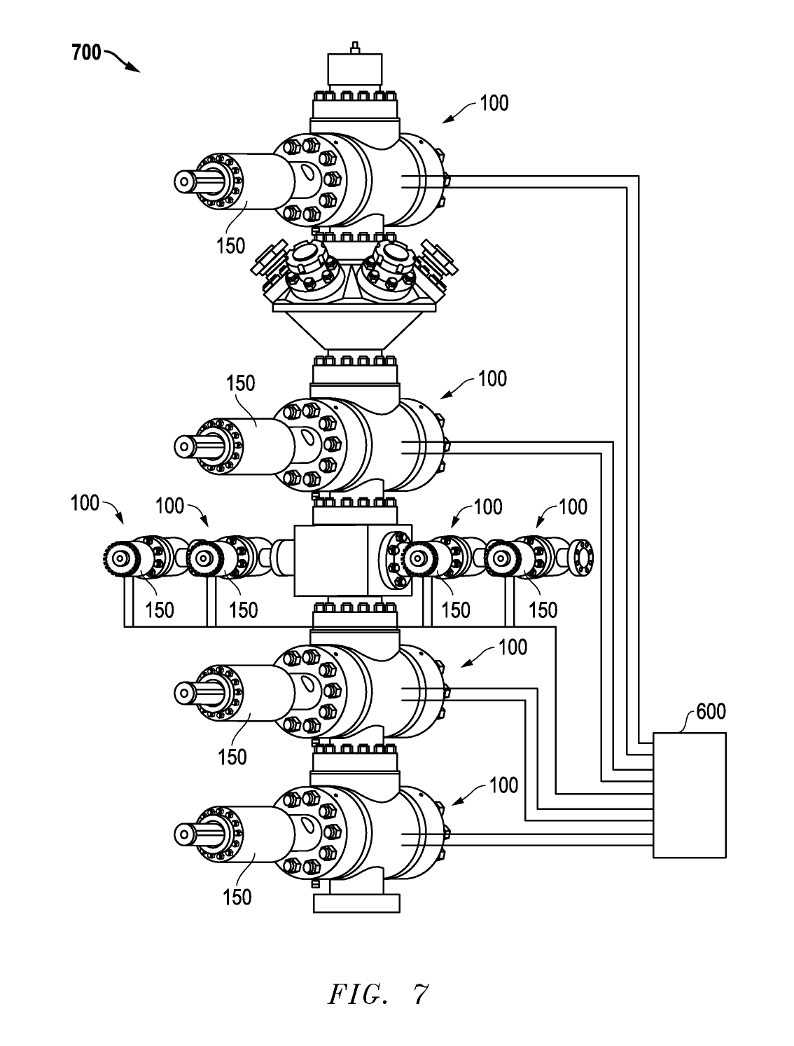

FIG. 6 is a diagram illustrating an example of a known frac stack 10. FIG. 7 is a diagram illustrating an example of a remotely operated frac stack 700 using gate valve 100 including the PLC 600 in accordance with the present disclosure. In the oil and gas industry, one of the most common and popular practices to stimulate the bearing oil and gas formation or reservoir is the hydraulic fracturing method. This stimulation method requires extremely high pressure injection of fluid into the formation. Safety of personnel is always of great concern because of high pressure injections. Accordingly, the remotely controlled hydraulic supply and controls and the sequential operation of the gate valve 100 reduces and prevents safety concerns that are typically experienced by operation personnel in using the prior art frac stack 10.

The remotely operated hydraulic frac stack 700, the sequential operation of the hydra seal assemblies 500, and the design of the hydraulic control system and PLC 600 will regulate the output of hydraulic supply pressure to the main hydraulic actuation mechanism 150 and to the hydra seal assemblies 500, as described above. Accordingly, this allows remotely controlling the frac stack 700 and prevents any safety concerns to operation personnel.

The corrosive properties of the fluid material intended to be used in the gate valve system 100, as well as the pressure rating specified, play a role in determining the materials utilized to form the gate valve system 100. In the oil and gas industry, common corrosive fluids include carbon dioxide, chloride, methane, and hydrogen sulfide. For applications that subject the gate valve system 100 to such fluids, the gate valve system 100 can be fabricated from well-known corrosion resistant materials such as those with a high nickel content. Exemplary and non-limiting materials may include Inconel alloys (e.g., Inconel 625), duplex titanium, or other duplex materials. In a gate valve system 100 with smaller dimensions, the whole gate valve system 100 may be fabricated from a corrosion-resistant material. However, as the gate valve system 100 becomes larger, it may not be economically feasible to fabricate the gate valve system 100 using only these specialized corrosive-resistant materials. In such a case, a standard material, such as AISI 4130, may be utilized as an outer material, which provides support to the valve body 110 and first and second bonnets 130, 140, respectively. To meet corrosion resistance specifications, a nickel-based material may be inlayed inside the body bore 200, the first and second bonnets 130, 140, respectively, the gate 400, and other areas in contact with the corrosive fluid. Further, it may be beneficial to use more than one corrosion-resistant material in the gate valve system 100. The choice of material is a design and manufacturability decision commonly known and applied by one of skill in the art and does not limit this invention. A person of skill in the art will recognize that this invention is not limited to any particular material and reference to materials are only provided as exemplary disclosure of a typical gate valve system 100 in the oil and gas industry.

It will be appreciated by those skilled in the art that changes could be made to the embodiments described above without departing from the broad inventive concept thereof. It is understood, therefore, that the invention disclosed herein is not limited to the particular embodiments disclosed, but it is intended to cover modifications within the spirit and scope of the present invention as defined by the appended claims.

What is claimed is:

1. A gate valve system, comprising:
a valve body comprising a bore configured to allow fluid to pass through the valve body;
a gate disposed within the cavity and comprising a passage configured to allow fluid to pass;
a gate actuation mechanism configured to actuate the gate for substantially permitting or impeding fluid flow;
a seal assembly adjacent to the gate configured to be actuated for compressing against the gate; and
a programmable controller configured to control the gate actuation mechanism and actuation of the seal assembly.

2. The gate valve system of claim 1, further comprising a machined bore or pocket formed in the valve body for housing the seal assembly.

3. The gate valve system of claim 1, further comprising a hydraulic supply port disposed on an outer surface of the valve body for supplying hydraulic fluid to the seal assembly.

4. The gate valve system of claim 1, wherein the programmable controller is configured to indicate an amount of pressure within a bore of the gate valve for determining a position of the seal assembly.

5. The gate valve system of claim 1, wherein the programmable controller is configured to indicate an amount of hydraulic supply to the gate actuation mechanism for determining a position of the gate.

6. The gate valve system of claim 1, further comprising a bonnet that is removably coupled to a face of the valve body and comprises a connecting end, wherein an innerside of the bonnet comprises a curved surface adapted to mate with an end of the gate.

7. The gate valve system of claim 6, further comprising a second bonnet removably coupled to a second face of the valve body, wherein an innerside of the second bonnet includes a curved surface adapted to mate with another end of the gate.

8. The gate valve system of claim 7, wherein each of the innerside of the first bonnet and the innerside of the second bonnet is an arcuate concave dome.

9. The gate valve system of claim 7, further comprising a detection mechanism operationally positioned and removably connected to the gate by way of a hole in the second bonnet, whereby the detection mechanism indicates a location of the gate within the valve body.

10. The gate valve system of claim 9, wherein an attachment of the detection mechanism and the gate actuation mechanism are operationally interchangeable with the first bonnet and the second bonnet.

11. The gate valve system of claim 1, further comprising a detection mechanism for indicating a location of the gate within the valve body.

12. The gate valve system of claim 11, wherein the detection mechanism comprises a first switch for detecting a fully open position of the gate and a second switch for detecting a fully closed position of the gate, and is configured to transmit a first signal to the programmable controller in response to the first switch being activated and a second signal to the programmable controller in response to the second switch being activated.

13. The gate valve system as in claim 1, wherein the gate actuation mechanism is capable of being removed without affecting a sealing capability of the valve body.

14. The gate valve system of claim 1, wherein the seal assembly comprises a first seal adjacent a first face of the gate and a second seal adjacent a second face of the gate.

15. A gate valve system, comprising:
a valve body comprising a bore configured to allow fluid to pass through the valve body;
a gate disposed within the cavity and comprising a passage configured to allow fluid to pass;
a gate actuation mechanism configured to actuate the gate for substantially permitting or impeding fluid flow;
a seal assembly adjacent to the gate configured to be actuated for compressing against the gate; and
a switch mechanism for detecting a position of the gate actuation mechanism and the gate.

16. The gate valve system of claim 15, wherein the switch mechanism comprises a first switch for detecting a fully open position of the gate and a second switch for detecting a fully closed position of the gate, and configured to transmit a first signal in response to the first switch being activated and a second signal in response to the second switch being activated.

17. The gate valve system of claim 16, further comprising a programmable controller for controlling actuation of the seal assembly in response to receiving the first signal or the second signal from the switch mechanism.

18. A method of using a gate valve system comprising a gate and a seal assembly, the method comprising:
actuating the gate to a fully open position using a hydraulic actuator;
detecting the fully open position of the gate using a first switch; and
actuating the seal assembly to a sealing position in response to the detecting of the fully open position.

19. The method of claim 18, further comprising:
actuating the seal assembly to a non-sealing position;
detecting the non-sealing position by determining a pressure within the gate valve system;
actuating the gate to a fully closed position in response to the detecting of the non-sealing position;
detecting the fully closed position of the gate using a second sensor; and
actuating the seal assembly to a sealing position in response to the detecting of the fully closed position.

20. The method of claim 19, wherein the actuating of the gate in response to the detecting of the non-sealing position comprises actuating of the gate after a period of time from the detecting of the non-sealing position.
